(19) United States
(12) Patent Application Publication
(10) Pub. No.: US 2007/0076356 A1
(43) Pub. Date: Apr. 5, 2007

(54) ELECTRONIC DEVICE AND VENTILATION APPARATUS THEREOF

(75) Inventor: CHIA-CHIN CHIANG, Tu-Cheng,Taipei Hsien (TW)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/309,477

(22) Filed: Aug. 11, 2006

(30) Foreign Application Priority Data
Sep. 30, 2005 (TW) 94134326

(51) Int. Cl. H02B 1/56

(52) U.S. Cl. 361/678

(57) ABSTRACT

A ventilation apparatus includes a sidewall (24) including a plurality of aligned connecting portions (245), and a plurality of ribs (244). A plurality of through holes (242) is defined between every two adjacent connecting portions, and one of the through holes is defined above one of the connecting portions but below the top portion. Each rib extends in from the corresponding connecting portion and is tilted.

### FIELD OF THE INVENTION

The present invention relates to an electronic device, and more particularly to an electronic device with a ventilation apparatus for dissipating heat and preventing dust from entering the electronic device.

### DESCRIPTION OF RELATED ART

Due to the operation of electronic components in an electronic device, such as a personal computer, a notebook computer, a television and so on, heat is generated in the electronic device. The electronic components in the electronic device may be exceptionally temperature sensitive, so that the heat generated may damage the electronic components. Therefore, heat dissipation for the electronic device is necessary.

Referring to FIG. 6, a conventional electronic device 10 includes two opposite sidewalls 100. Each sidewall 100 comprises a plurality of aligned connecting portions 105 parallel to each other. Each sidewall 100 further comprises a plurality of through holes 102 defined between every two adjacent connecting portions 105 and one of the through holes 102 is defined between one of the connecting portions 105 and a top portion 109 of the electronic device 10. The electronic device 10 further includes a plurality of ribs 104. Each rib 104 is perpendicular to the sidewalls 100 and extends from the corresponding connecting portion 105 toward an interior of the electronic device 10. Each rib 104 comprises a distal end portion 106 extending up parallel to the sidewalls 100. A gap or channel 108 is defined between every two adjacent end portions 106 in communication with the corresponding through hole 102. A width of each gap 108 is less than that of the corresponding through hole 102, thus preventing dust or similar impurities from entering the electronic device 10. However, these end portions 106 may cause resistance to air currents and reduce the effect of heat dissipation, thus degrading the performance of the electronic device 10.

Therefore, a heretofore unaddressed need exists in the industry to overcome the aforementioned deficiencies and inadequacies.

### SUMMARY OF THE INVENTION

In an exemplary embodiment, a ventilation apparatus includes a sidewall including a plurality of aligned connecting portions, and a plurality of ribs. A plurality of through holes is defined between every two adjacent connecting portions, and one of the through holes is defined above one of the connecting portions below the top portion. Each rib is tilted, and extends in from the corresponding connecting portion.

Other advantages and novel features will become more apparent from the following detailed description of preferred embodiments when taken in conjunction with the accompanying drawings, in which:

### BRIEF DESCRIPTION OF THE DRAWINGS

FIG. 1 is a partly cut-away isometric view of an electronic device of an exemplary embodiment of the present invention;

FIG. 2 is an elevation view of the electronic device of FIG. 1;

FIG. 3 is an enlarged view of a circled portion III of FIG. 2;

FIG. 4 is an enlarged view of a ventilation apparatus of another exemplary embodiment of the present invention;

FIG. 5 is an enlarged view of a ventilation apparatus of yet another exemplary embodiment of the present invention; and

FIG. 6 is a sectional elevation view of a conventional electronic device.

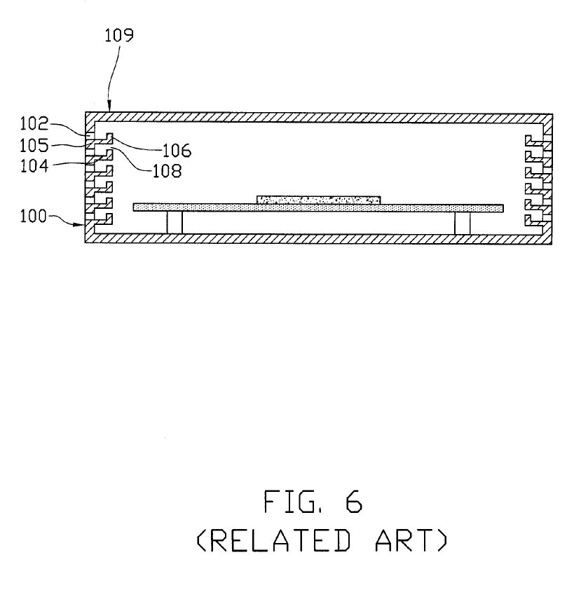

### DETAILED DESCRIPTION OF THE INVENTION

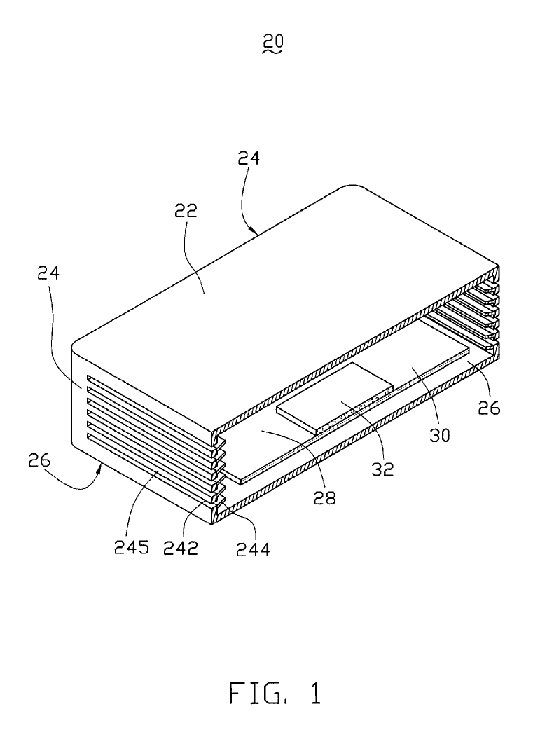

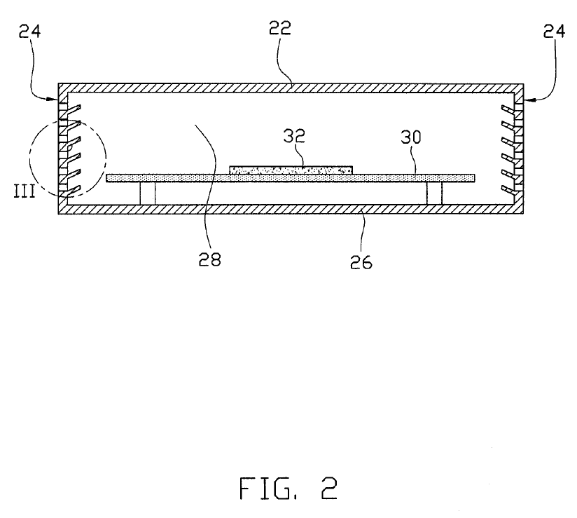

Referring to FIGS. 1 and 2, an electronic device 20 of an exemplary embodiment of the present invention comprises a top portion 22, a bottom portion 26, and a plurality of sidewalls 24. The sidewalls 24 are perpendicularly connected to the top portion 22 and the bottom portion 26. The top portion 22, the bottom portion 26, and the sidewalls 24 cooperatively form a receiving space 28. The electronic device 20 further comprises a circuit board 30 received in the receiving space 28. The circuit board 30 comprises a heat-generating electronic component 32 disposed thereon.

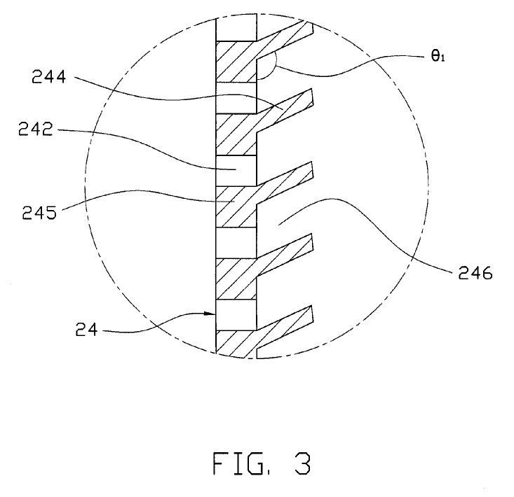

Referring also to FIG. 3, each opposite sidewall 24 comprises a plurality of connecting portions 245 aligned with and parallel to each other. Each sidewall 24 further comprises a plurality of through holes 242 defined between every two adjacent connecting portions 245, and one of the through holes 242 is defined above one of the connecting portions 245 but below the top portion 22. The electronic device 20 further comprises a plurality of ribs 244. Each rib 244 extends in from the corresponding connecting portion 245 toward the receiving space 28 of the electronic device 20 and is tilted to form a bevel angle θ₁ with respect to the sidewall 24 so as to prevent dust or impurities from entering the receiving space 28. The sidewalls 24 and the ribs 244 form a ventilation apparatus. In this exemplary embodiment, each rib 244 is tilted up.

Every two adjacent ribs 244 define a channel 246 in communication with the corresponding through hole 242. A thickness of each rib 244 is less than a width of the connecting portion 245 so as to make each channel 246 be wider than the corresponding through hole 242.

With each channel 246 being wider than the corresponding through hole 242, ventilation resistance is reduced such that air can easily pass through the channels 246 and the through holes 242 so as to facilitate the ventilation of the electronic device 20, thus ensuring effective heat dissipation of the electronic device 20. In addition, since each rib 244 extends in from the connecting portion 245 toward the receiving space 28 of the electronic device 20 and is tilted up to form the angle θ₁ with respect to the sidewall 24, the electronic device 20 also prevents dust or impurities from entering therein.

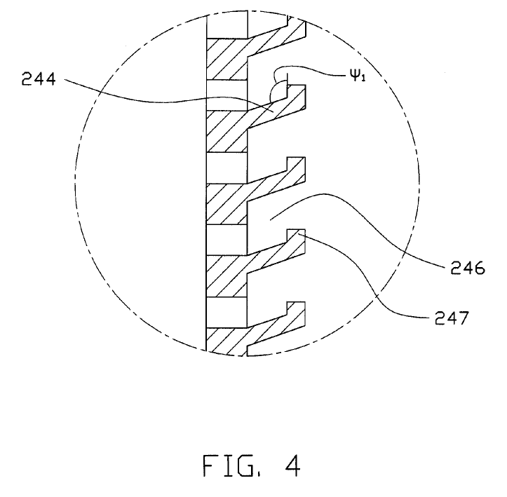

In another exemplary embodiment, referring to FIG. 4, an enlarged view of the ventilation apparatus of the present invention is shown. Each of the ribs 244 further comprises a plurality of end portions 247 extending up from an end thereof. Each of the end portions 247 is perpendicular to the top portion 22 and the bottom portion 26, and an angle ψ₁ is formed between each end portion 246 and the corresponding rib 244. The angle ψ₁ is equal to the angle θ₁. In this exemplary embodiment, a minimum width of each channel 246 is greater than that of the corresponding through hole 242. The end portions 246 effectively prevent dust or the impurities from entering the electronic device 20 during operation.

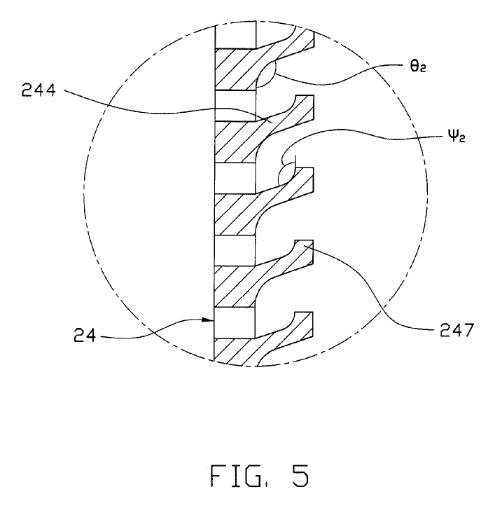

In another exemplary embodiment, referring to FIG. 5, an enlarged view of the ventilation apparatus of the present invention is shown. In this exemplary embodiment, a fillet angle θ₂and a fillet angle ψ₂ are defined as follows. The fillet angle θ₂ is formed between each rib 244 and the sidewall 24, while the fillet angle ψ₂ is formed between each rib 244 and the corresponding end portion 246. The angles θ₂ and ψ₂ are equal to the angle θ₁ and ψ₁ , respectively. Other portions or components are the same as the above description. As a result, the ventilation resistance is greatly reduced thereby greatly facilitating the ventilation of the electronic device 20. Therefore, the heat dissipation of the electronic device 20 and the performance of the electronic component 32 in the electronic device 20 are improved.

While exemplary embodiments have been described above, it should be understood that they have been presented by way of example only and not by way of limitation. Thus the breadth and scope of the present invention should not be limited by the above-described exemplary embodiments, but should be defined only in accordance with the following claims and their equivalents.

What is claimed is:

1. A ventilation apparatus, comprising:
a sidewall comprising a plurality of aligned connecting portions, and a plurality of through holes defined between every two adjacent connecting portions and one of the through holes is defined above one of the connecting portions but below the top portion; and
a plurality of ribs each extending in from the corresponding connecting portion and being tilted.

2. The ventilation apparatus as claimed in claim 1, wherein every two adjacent ribs cooperatively define a channel therebetween communicating with the corresponding through hole.

3. The ventilation apparatus as claimed in claim 2, wherein a width of each channel is greater than that of the corresponding through hole.

4. The ventilation apparatus as claimed in claim 1, wherein each of the ribs and the corresponding sidewall cooperatively define a bevel angle therebetween.

5. The ventilation apparatus as claimed in claim 4, wherein the angle is a fillet angle.

6. The ventilation apparatus as claimed in claim 1, wherein each rib further comprises a plurality of end portions extending up from an end thereof.

7. The ventilation apparatus as claimed in claim 6, wherein each rib and the corresponding end portion cooperatively define a bevel angle therebetween.

8. The ventilation apparatus as claimed in claim 7, wherein the angle is a fillet angle.

9. An electronic device, comprising:
a circuit board received in the electronic device;
a sidewall comprising a plurality of aligned connecting portion, and a plurality of through holes defined between every two adjacent connecting portions and one of the through holes is defined above one of the connecting portions and below the top portion; and
a plurality of ribs each extending in from the corresponding connecting portion and being tilted.

10. The electronic device as claimed in claim 9, wherein every two adjacent ribs cooperatively define a channel in communication with the corresponding through hole.

11. The electronic device as claimed in claim 1 0, wherein a width of each channel is greater than that of the corresponding through hole.

12. The electronic device as claimed in claim 9, wherein each of the ribs and the corresponding sidewall cooperatively define a bevel angle therebetween.

13. The electronic device as claimed in claim 12, wherein the angle is a fillet angle.

14. The electronic device as claimed in claim 9, wherein each rib further comprises a plurality of end portions extending up from an end thereof.

15. The electronic device as claimed in claim 14, wherein each rib and the corresponding end portion cooperatively define a bevel angle therebetween.

16. The electronic device as claimed in claim 15, wherein the angle is a fillet angle.

17. An electronic device comprising:
a heat-generating component installable in said electronic device; and
a sidewall of said electronic device extending along a side of said electronic device, said sidewall defining a plurality of ventilation through holes therein to provide air passageways for said electronic device, and a plurality of corresponding connecting portions of said sidewall formed between every two adjacent through holes respectively, a rib extending slantwise from each of said plurality of corresponding connecting portions into said electronic device toward one of said every two adjacent through holes so that a projection of said rib falls within an area of said one of said every two adjacent through holes, and a distance between extending free ends of every two adjacent ribs being larger than a distance between every two adjacent connecting portions where said every two adjacent ribs extend therefrom correspondingly.
